(19) United States
(12) Patent Application Publication
(10) Pub. No.: US 2026/0081555 A1
(43) Pub. Date: Mar. 19, 2026

(54) ATTACHMENT STRUCTURE FOR VEHICLE SOLAR PANEL

(71) Applicants: TOYOTA JIDOSHA KABUSHIKI KAISHA, Toyota-shi (JP); AGC INC., Tokyo (JP); Sharp Energy Solutions Corporation, Osaka (JP)

(72) Inventors: Shirou NAKANO, Miyoshi-shi (JP); Yoshio KOSAKA, Tokyo (JP); Hajime HORINAKA, Kashiba-shi (JP); Yasushi YOSHIKAWA FUNAKOSHI, Uda-shi (JP)

(73) Assignees: TOYOTA JIDOSHA KABUSHIKI KAISHA, Toyota-shi (JP); AGC INC., Tokyo (JP); Sharp Energy Solutions Corporation, Osak (JP)

(21) Appl. No.: 19/291,015

(22) Filed: Aug. 5, 2025

(30) Foreign Application Priority Data
Sep. 19, 2024 (JP) 2024-162458

(51) Int. Cl. H02S 20/30; B60R 11/00

(52) U.S. Cl. CPC H02S 20/30; B60R 11/00; B60R 2011/004

(57) ABSTRACT

An attachment structure for vehicle solar panel includes: a vehicle-body configuring member configuring a part of a vehicle body; a solar panel provided on the vehicle-body configuring member, the solar panel including a glass exposed to an outside of the vehicle body, and a solar module provided on a vehicle inner-side surface of the glass; and a coupling member that couples the vehicle-body configuring member and the solar module. The coupling member includes: a panel-side attachment portion connected to the solar module; a vehicle-body-side attachment portion connected to the vehicle-body configuring member; and a connection portion that connects the panel-side attachment portion and the vehicle-body-side attachment portion and has flexibility.

### CROSS-REFERENCE TO RELATED APPLICATION

This application claims priority to Japanese Patent Application No. 2024-162548 filed on Sep. 19, 2024, incorporated herein by reference in its entirety.

### BACKGROUND

### 1. Technical Field

The disclosure relates to an attachment structure for vehicle solar panel.

### 2. Description of Related Art

Japanese Unexamined Patent Application Publication No. 2015-229916 (JP 2015-229916 A) discloses an attachment structure for solar panel that allows a solar panel to be attached to an attached member via a bracket.

### SUMMARY

A solar panel includes a glass, and a solar module that is positioned on an inner side of the glass to generate electric power with the use of sunlight. Accordingly, when some type of object collides with the glass, a force is applied from the solar module to the attached member via the bracket, and a reaction force generated by the attached member may be transmitted to the solar module via the bracket. In this case, the solar module (a solar cell) may be damaged, or disconnection may occur.

Here, a case where the attachment structure for solar panel of JP 2015-229916 A is applied to a vehicle is assumed. When the solar panel is attached to the vehicle as described above, the possibility that the above-mentioned problems occur is increased.

The present disclosure has been made in consideration of the above-mentioned facts, and has an object to obtain an attachment structure for vehicle solar panel in which a possibility that a solar module of a solar panel provided on a vehicle flies away can be reduced, and the solar panel is less liable to receive a reaction force from a vehicle-body configuring member when the solar panel is moved to the vehicle-body configuring member side.

An attachment structure for vehicle solar panel according to claim 1 includes: a vehicle-body configuring member configuring a part of a vehicle body; a solar panel provided on the vehicle-body configuring member, the solar panel including a glass exposed to an outside of the vehicle body, and a solar module provided on a vehicle inner-side surface of the glass; and a coupling member that couples the vehicle-body configuring member and the solar module. The coupling member includes: a panel-side attachment portion connected to the solar module; a vehicle-body-side attachment portion connected to the vehicle-body configuring member; and a connection portion that connects the panel-side attachment portion and the vehicle-body-side attachment portion and has flexibility.

In the attachment structure for vehicle solar panel of claim 1, the solar panel includes the glass exposed to the outside of the vehicle body, and the solar module provided on the vehicle inner-side surface of the glass. It is to be noted that the glass as used herein includes a cover member that coats the surface of the glass and has permeability.

Accordingly, for example, when a stone or the like collides with the glass, the glass may be damaged. However, the attachment structure for vehicle solar panel of claim 1 includes the coupling member including the panel-side attachment portion connected to the solar module, the vehicle-body-side attachment portion connected to the vehicle-body configuring member, and the connection portion that connects the panel-side attachment portion and the vehicle-body-side attachment portion and has flexibility. Thus, the attachment structure for vehicle solar panel of claim 1 can reduce the possibility that the solar module flies toward surroundings of the vehicle body even if the glass is damaged.

Moreover, the vehicle-body configuring member is sometimes a member that is movable, for example, a hood. In this case, when the vehicle-body configuring member comes into contact with another part of the vehicle body while moving relative to the other part, an inertia force acts on the solar panel, and the solar module tries to move to the vehicle-body configuring member side. However, the connection portion of the coupling member has flexibility, and hence there is a small possibility that a moving force of the solar module acts on the vehicle-body configuring member via the coupling member and the vehicle-body configuring member generates a large reaction force. Accordingly, there is a small possibility that such a reaction force is transmitted to the solar module via the coupling member. Accordingly, there is a small possibility that a connection portion between the solar module and the panel-side attachment portion is damaged.

As the attachment structure for vehicle solar panel according to claim 2, in claim 1, the vehicle-body-side attachment portion may be a clip including a first engagement portion configured to pass through an attachment hole provided in the vehicle-body configuring member having a plate shape, from one surface side to another surface side of the vehicle-body configuring member while being elastically deformed, the first engagement portion being brought into contact with the other surface after passing through the attachment hole, and a second engagement portion to be brought into contact with the one surface after the first engagement portion passes through the attachment hole, the clip being fixed to the glass.

In the attachment structure for vehicle solar panel of claim 2, when the vehicle-body-side attachment portion being the clip is attached to the attachment hole provided in the plate-shaped vehicle-body configuring member, the solar panel is positioned in the vehicle-body configuring member.

As the attachment structure for vehicle solar panel according to claim 3, in claim 1, the panel-side attachment portion may face one surface of the vehicle-body configuring member having a plate shape, and may be fixed to the solar module. The connection portion may pass through a through-hole provided in the vehicle-body configuring member so as to be movable relative to the through-hole. The vehicle-body-side attachment portion may face, from another surface side of the vehicle-body configuring member, the other surface, and may be larger in diameter than the through-hole.

In the attachment structure for vehicle solar panel of claim 3, when a force in a direction approaching the vehicle-body configuring member acts on the solar panel, the connection portion moves relative to the vehicle-body configuring member an inside of the through-hole provided in the vehicle-body configuring member, and thus this force is absorbed. Accordingly, this force is less liable to act on the vehicle-body configuring member. Accordingly, there is a small possibility that the vehicle-body configuring member generates a large reaction force and this reaction force is transmitted to the solar module via the coupling member. Moreover, when a force in a direction separating from the vehicle-body configuring member acts on the solar panel, the vehicle-body-side attachment portion larger in diameter than the through-hole does not pass through the through-hole to move to the one surface side of the vehicle-body configuring member. Accordingly, in this case, there is a small possibility that the solar module flies away.

As the attachment structure for vehicle solar panel according to claim 4, in claim 1, the panel-side attachment portion may be bonded to the solar module, and a part of the connection portion may be a low rigidity portion that is lower in rigidity than another part of the connection portion.

In the attachment structure for vehicle solar panel of claim 4, when a force in a direction separating from the vehicle-body configuring member acts on the solar panel, the low rigidity portion that is a part of the connection portion is deformed to absorb this force. Accordingly, in this case, there is a small possibility that the panel-side attachment portion is separated from the solar module due to this force. Thus, the solar module is less liable to fly away.

As the attachment structure for vehicle solar panel according to claim 5, in claim 1, one surface in a thickness direction of the panel-side attachment portion having flexibility may be a first surface bonded to the solar module, and a second surface that is another surface in the thickness direction of the panel-side attachment portion may include at least one recessed portion.

In the attachment structure for vehicle solar panel of claim 5, when a force in a direction separating from the vehicle-body configuring member acts on the solar panel, the panel-side attachment portion including the recessed portion and having flexibility is deformed to absorb this force. Accordingly, in this case, there is a small possibility that the panel-side attachment portion is separated from the solar module due to this force. Thus, the solar module is less liable to fly away.

As the attachment structure for vehicle solar panel according to claim 6, in claim 1, a support member may be fixed to the solar module, the support member including a facing portion that faces the solar module while being separated from the solar module. The panel-side attachment portion may be positioned in a space between the solar module and the facing portion, and may be larger in diameter than a through-hole provided in the facing portion.

The connection portion may pass through the through-hole so as to be movable relative to the through-hole.

In the attachment structure for vehicle solar panel of claim 6, when a force in a direction separating from the vehicle-body configuring member acts on the solar panel, the facing portion (the through-hole) of the support member fixed to the solar module moves relative to the connection portion to absorb this force. Accordingly, in this case, there is a small possibility that the panel-side attachment portion is separated from the solar module due to this force. Further, the panel-side attachment portion is larger in diameter than the through-hole provided in the facing portion, and hence the solar module is prevented from flying away by the panel-side attachment portion and the facing portion.

In the attachment structure for vehicle solar panel according to claim 7, in claim 1, the panel-side attachment portion may include a temporary holding portion configured to temporarily hold a part of the connection portion.

In the attachment structure for vehicle solar panel of claim 7, when the work of attaching the solar panel to the vehicle-body configuring member is performed in a state in which the panel-side attachment portion is connected to the solar module, a possibility that the connection portion hinders this work can be reduced.

The attachment structure for vehicle solar panel according to the present disclosure has such an excellent effect that the possibility that the solar module of the solar panel provided in the vehicle flies away can be reduced and the solar panel is less liable to receive the reaction force from the vehicle-body configuring member when the solar panel is moved to the vehicle-body configuring member side.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a front portion of a vehicle to which an attachment structure for vehicle solar panel according to an embodiment is applied;

FIG. 2 is a bottom view of a part of a hood of the vehicle;

FIG. 3 is a sectional view taken along the arrow line 3-3 of FIG. 2;

FIG. 4 is a sectional view of a glass and a solar module;

FIG. 5 is a schematic perspective view of a distal end portion of a first coupling member;

FIG. 6 is a sectional view taken along an arrow line 6-6 of FIG. 2;

FIG. 7 is a schematic perspective view of a distal end portion of a second coupling member;

FIG. 8 is a sectional view corresponding to FIG. 3 of a first modification example;

FIG. 9 is a sectional view corresponding to FIG. 8 when the solar panel is moved upward;

FIG. 10 is a sectional view corresponding to FIG. 3 of a second modification example;

FIG. 11 is a sectional view corresponding to FIG. 3 of a third modification example;

FIG. 12 is a sectional view corresponding to FIG. 3 of a fourth modification example;

FIG. 13 is a bottom view as viewed along an arrow A of FIG. 12;

FIG. 14 is a sectional view corresponding to FIG. 3 when an end portion of a connection portion of a first coupling member of a fifth modification example is temporarily held by a temporary holding portion; and

FIG. 15 is a sectional view corresponding to FIG. 3 of the fifth modification example.

### DETAILED DESCRIPTION OF EMBODIMENTS

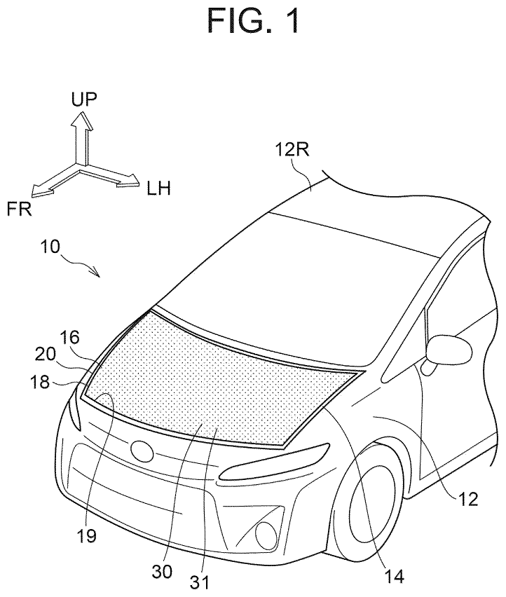

Hereinafter, an embodiment of an attachment structure for vehicle solar panel according to the present disclosure is described with reference to FIG. 1 to FIG. 7. It is to be noted that an arrow FR indicated as appropriate throughout the drawings indicates a vehicle front side that is a front side in a vehicle front-rear direction, an arrow LH indicates a vehicle left side that is a left side in a vehicle right-left direction, and an arrow UP indicates a vehicle upper side that is an upper side in a vehicle-height direction. In the following description, the front-rear direction, the right-left direction, and the up-down direction indicate the vehicle front-rear direction, the vehicle right-left direction, and the vehicle-height direction, respectively.

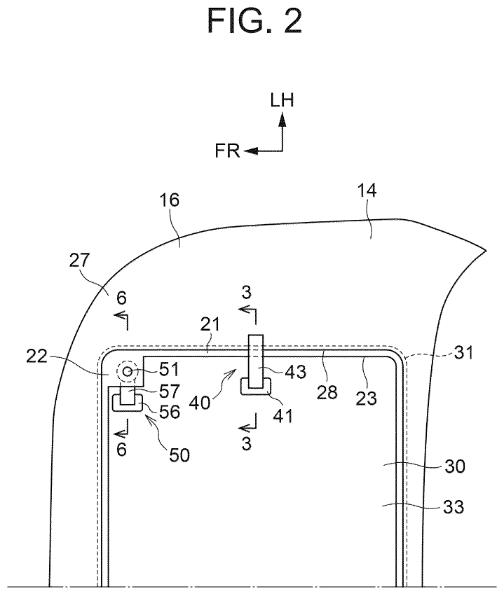

As illustrated in FIG. 1 and FIG. 2, in a front portion of a vehicle body 12 of a vehicle 10, a hood (a bonnet) (a vehicle-body configuring member) 14 that can open and close an upper portion of an engine compartment is provided. A rear end portion of the hood 14 is connected to the vehicle body 12 so as to be rotatable about a rotary axis extending in the right-left direction.

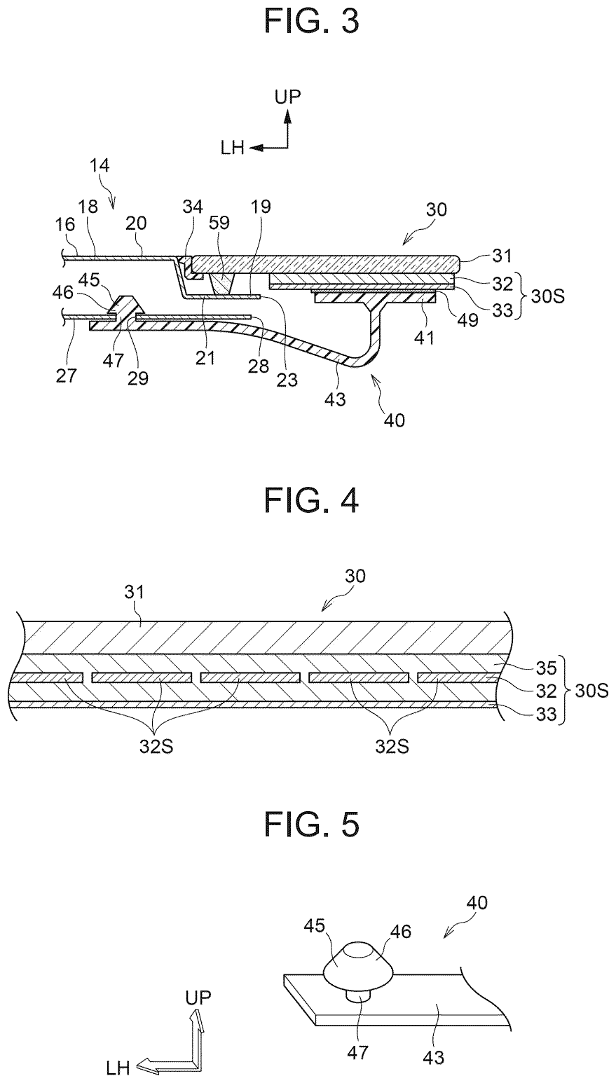

As illustrated in FIG. 2 and FIG. 3, the hood 14 includes a body 16 made of metal. The body 16 includes a hood outer panel (vehicle-body configuring member) 18 and a hood inner panel (vehicle-body configuring member) 27 that are both plate members made of metal and have substantially rectangular planar shapes.

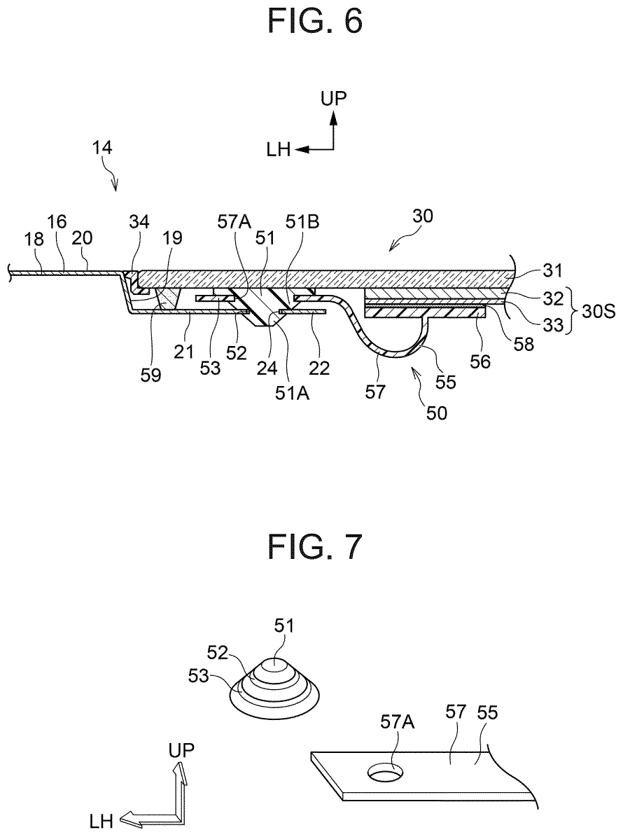

As illustrated in FIG. 2 and FIG. 3, in a part of an upper surface of the hood outer panel 18 positioned on an inner peripheral side from an outer peripheral edge portion, a recessed portion 19 that is recessed toward the hood inner panel 27 side and has a substantially rectangular shape in plan view is formed. That is, the hood outer panel 18 includes a bottom surface configuring portion 21 that is positioned one-stage downward of an outer surface configuring portion 20 configuring an outer surface of the hood 14. The bottom surface configuring portion 21 configures a bottom surface of the recessed portion 19 and has a substantially rectangular shape in plan view. As illustrated in FIG. 2, a support portion 22 is provided at a corner portion at which a left side edge portion and a front edge portion of the bottom surface configuring portion 21 intersect with each other. Moreover, in the bottom surface configuring portion 21, a through-hole 23 having a substantially rectangular shape in plan view is formed. Further, as illustrated in FIG. 6, in the support portion 22, a second attachment hole (an attachment hole) (a through-hole) 24 that is a circular through-hole is formed.

As illustrated in FIG. 2 and FIG. 3, in a part of the hood inner panel 27 positioned on an inner peripheral side from an outer peripheral edge portion, a through-hole 28 having a substantially rectangular shape in plan view is formed. Further, as illustrated in FIG. 3, in a left side portion of the hood inner panel 27, a first attachment hole 29 that is a circular through-hole is formed.

In the recessed portion 19 of the body 16, a solar panel 30 having a shape in plan view slightly smaller than the recessed portion 19 and having a substantially rectangular shape is provided. As illustrated in FIG. 4, the solar panel 30 of the present embodiment and each modification example to be described later includes a glass 31 made of a toughened glass that is a substantially-rectangular plate member configuring an outer surface (an upper surface) of the solar panel 30, a solar cell group 32 that is fixed to a lower surface of the glass 31 and has a substantially rectangular shape in plan view, a back sheet 33 fixed to a lower surface of the solar cell group 32, a gasket 34 that is a frame member fixed to an outer peripheral edge portion of the glass 31, and a sealing member 35 (not shown in FIG. 3) having translucency. It is to be noted that the solar cell group 32, the back sheet 33, and the sealing member 35 are components of a solar module 30S. As illustrated in FIG. 4, the solar cell group 32 of the present embodiment and each modification example to be described later includes a plurality of solar cells 32S, and each of the solar cells 32S is entirely covered with the sealing member 35. In other words, a large number of solar cells 32S, the glass 31, and the back sheet 33 are integrated by the sealing member 35. As is well-known, each of the solar cells 32S executes electric power generation operation by using sunlight. The shape of the entire solar cell group 32 in plan view is smaller than the glass 31, and the shape of the back sheet 33 in plan view is substantially equal to the shape of the entire solar cell group 32 in plan view. The shape of the entire solar cell group 32 in plan view and the shape of the back sheet 33 in plan view are substantially equal to the through-holes 23, 28. It is to be noted that the glass 31 may use a laminated glass in which a pair of glass plates is laminated via an intermediate film. Examples of an organic resin configuring the intermediate film include an ethylene-vinyl acetate copolymer (EVA) and polyvinyl butyral (PVB).

As illustrated in FIG. 2 to FIG. 5, in the vicinity of a left side edge portion of a lower surface of the back sheet 33 of the solar panel 30, a part of a first coupling member (coupling member) 40 that is an integrally molded product made of resin is fixed.

As illustrated in FIG. 3 and FIG. 5, the first coupling member 40 includes a panel-side attachment portion 41, a connection portion 43, and a vehicle-body-side attachment portion 45. The first coupling member 40 has flexibility. The panel-side attachment portion 41 is a plate-shaped portion having a substantially rectangular planar shape, and an upper surface of the panel-side attachment portion 41 is fixed to the vicinity of the left side edge portion of the lower surface of the back sheet 33 via an adhesive 49. A first end portion of the band-shaped connection portion 43 is fixed to the panel-side attachment portion 41. A second end portion of the connection portion 43 is fixed to the vehicle-body-side attachment portion 45. The vehicle-body-side attachment portion 45 includes a main body portion 46 having a shape of a cone with its top portion being planarly cut, and a cylindrical portion 47 that is connected to one surface of the main body portion 46 and has a diameter smaller than that of the main body portion 46. An end portion of the cylindrical portion 47 on a side opposite to the main body portion 46 is fixed to the connection portion 43. The outer diameter of the cylindrical portion 47 is smaller than the diameter of the first attachment hole 29, and the outer diameter of the end portion of the main body portion 46 on the cylindrical portion 47 side is larger than the diameter of the first attachment hole 29.

As illustrated in FIG. 2, FIG. 6, and FIG. 7, a part of a second coupling member (coupling member) 50 is fixed to the lower surface of the back sheet 33 of the solar panel 30 in the vicinity of the corner portion at which the left side edge portion and the front edge portion intersect.

As illustrated in FIG. 6 and FIG. 7, the second coupling member 50 includes a vehicle-body-side attachment portion 51 and a main body portion 55 that are both made of resin. The vehicle-body-side attachment portion 51 is a member (a clip) having a shape of a cone with its top portion being planarly cut. In an outer peripheral surface of the vehicle-body-side attachment portion 51, a first annular groove 52 and a second annular groove 53 that both have annular shapes are formed. The second annular groove 53 is larger in diameter than the first annular groove 52. An upper surface of the vehicle-body-side attachment portion 51 is fixed to the lower surface of the glass 31 by an adhesive. The main body portion 55 having flexibility integrally includes a panel-side attachment portion 56 and a connection portion 57. The panel-side attachment portion 56 is a plate-shaped portion having a substantially rectangular planar shape, and an upper surface of the panel-side attachment portion 56 is fixed to the lower surface of the back sheet 33 via an adhesive 58 in the vicinity of the above-mentioned corner portion. A first end portion of the band-shaped connection portion 57 is fixed to a middle portion of the panel-side attachment portion 56. In a second end portion of the connection portion 57, an attachment hole 57A that is a circular through-hole is formed. The diameter of the attachment hole 57A is substantially equal to the second annular groove 53 of the vehicle-body-side attachment portion 51, and is smaller than the outer diameter of the maximum diameter portion (an upper end portion) of the vehicle-body-side attachment portion 51. The second annular groove 53 of the vehicle-body-side attachment portion 51 is fitted to an outer peripheral edge portion of the attachment hole 57A of the connection portion 57. In this manner, the vehicle-body-side attachment portion 51 and the main body portion 55 are integrated.

The solar panel 30 integrated with the first coupling member 40 and the second coupling member 50 as described above is fixed to the hood 14 by, for example, the following method.

First, an adhesive 59 is applied to an outer peripheral portion of the lower surface of the glass 31. Subsequently, while the outer peripheral portion of the solar panel 30 is positioned directly above an outer peripheral portion of the recessed portion 19, the solar panel 30 is caused to approach the recessed portion 19 from the upper side of the hood 14. When the solar panel 30 is further moved to the bottom surface side of the recessed portion 19, as illustrated in FIG. 6, a first engagement portion 51A (a small-diameter end portion) that is a lower end portion of the vehicle-body-side attachment portion 51 passes downward through the second attachment hole 24 of the support portion 22 while being elastically deformed, and thus the first annular groove 52 of the vehicle-body-side attachment portion 51 is fitted to the outer peripheral edge portion of the second attachment hole 24 of the support portion 22 (see FIG. 6). This allows the first engagement portion 51A to come into contact with a lower surface of the support portion 22, and also allows a second engagement portion 51B that is a part positioned between the first annular groove 52 and the second annular groove 53 of the vehicle-body-side attachment portion 51 to come into contact with an upper surface of the support portion 22. That is, with the vehicle-body-side attachment portion 51, the solar panel 30 is positioned in the recessed portion 19 (the bottom surface configuring portion 21). Moreover, the adhesive 59 comes into contact with an upper surface of the bottom surface configuring portion 21 of the hood outer panel 18, and thus the gasket 34 comes into close contact with the outer peripheral edge portion of the recessed portion 19. In this manner, the solar panel 30 is fixed to the body 16 (the recessed portion 19).

Moreover, as illustrated in FIG. 3, the vehicle-body-side attachment portion 45 of the first coupling member 40 is caused to approach the hood inner panel 27 from below, and an upper end portion (a small-diameter end portion) of the main body portion 46 is pushed into the first attachment hole 29 of the hood inner panel 27. In this manner, the main body portion 46 passes upward through the first attachment hole 29 while being elastically deformed, and the cylindrical portion 47 is positioned within the first attachment hole 29.

### Actions and Effects

Next, actions and effects of the embodiment are described.

The solar panel 30 of the present embodiment includes the glass 31 exposed to the outside of the vehicle 10, the solar cell group 32 provided on the vehicle inner-side surface of the glass 31, the back sheet 33 provided on the vehicle inner-side surface of the solar cell group 32, and the sealing member 35. Accordingly, the glass 31 may be damaged when a stone on a road surface flown up by a wheel during travel of the vehicle 10 collides with the glass 31.

However, the entire solar cell group 32 is attached to the back sheet 33 via the sealing member 35. Accordingly, even when the glass 31 is cracked, the action of the sealing member 35 reduces the possibility that the solar cell group 32, the back sheet 33, and the sealing member 35 are divided into a plurality of parts. Moreover, the first coupling member 40 includes the panel-side attachment portion 41 fixed to the back sheet 33, the vehicle-body-side attachment portion 45 connected to the hood 14 (the hood inner panel 27), and the connection portion 43 that connects the panel-side attachment portion 41 and the vehicle-body-side attachment portion 45 and has flexibility. Moreover, the second coupling member 50 includes the panel-side attachment portion 56 fixed to the back sheet 33, the vehicle-body-side attachment portion 51 connected to the hood 14 (the hood outer panel 18), and the connection portion 57 that connects the vehicle-body-side attachment portion 51 and the panel-side attachment portion 56 and has flexibility. Thus, even if the glass 31 is damaged, with the first coupling member 40 and the second coupling member 50, the solar module 30S is prevented from being greatly moved from the hood 14 to the vehicle outer side. Accordingly, there is a small possibility that the solar module 30S flies toward surroundings of the vehicle body 12.

Moreover, the hood 14 on which the solar panel 30 is provided is movable relative to the vehicle body 12. That is, the hood 14 can open and close the vehicle body 12 between a closed position for closing the engine compartment and an open position for exposing the engine compartment. When the hood 14 at the open position is moved to the closed position, the hood 14 comes into contact with a part of the vehicle body 12, and thus an inertia force is generated in the solar panel 30 to move the solar panel 30 to the hood inner panel 27 side. However, the connection portion 43 of the first coupling member 40 and the connection portion 57 of the second coupling member 50 have flexibility, and hence there is a small possibility that a moving force of the solar panel 30 is transmitted to the hood outer panel 18 (the bottom surface configuring portion 21) and the hood inner panel 27 via the first coupling member 40 and the second coupling member 50 to cause the hood outer panel 18 and the hood inner panel 27 to generate a reaction force. Thus, there is a small possibility that a connection portion between the solar module 30S and the panel-side attachment portion 41 is damaged or the solar module 30S is damaged due to such a reaction force.

Hereinabove, the attachment structure for vehicle solar panel according to the embodiment has been described, but the design of the present disclosure can be changed as appropriate without departing from the gist of the present disclosure.

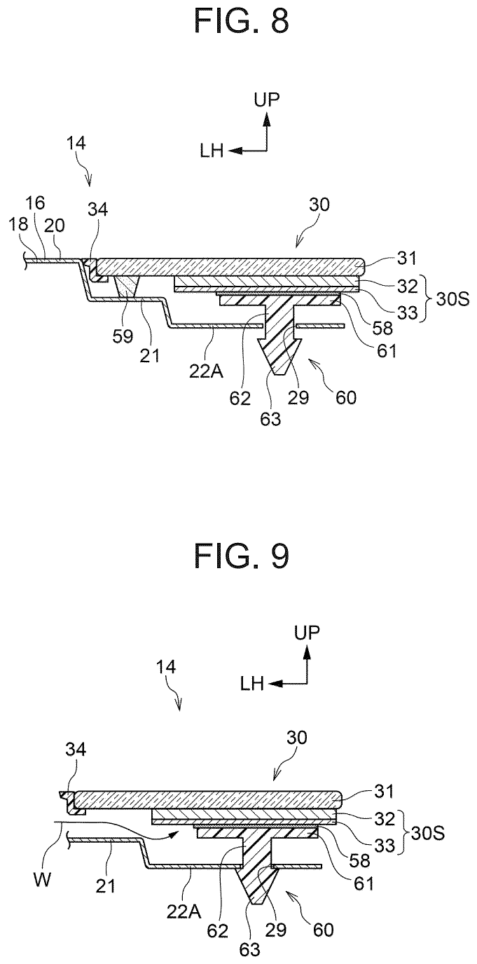

For example, the present disclosure may be carried out in an aspect of a first modification example illustrated in FIG. 8 and FIG. 9. In the attachment structure for vehicle solar panel of the first modification example, a support portion 22A is formed in the bottom surface configuring portion 21 of the hood outer panel 18 of the hood 14. The support portion 22A is positioned one-stage below other parts of the bottom surface configuring portion 21. Further, the first attachment hole (through-hole) 29 is formed in the support portion 22A.

A first coupling member (coupling member) 60 of the first modification example includes a panel-side attachment portion 61, a connection portion 62, and a vehicle-body-side attachment portion 63. The first coupling member 60 has flexibility. The panel-side attachment portion 61 is a plate-shaped portion having a substantially rectangular planar shape, and an upper surface of the panel-side attachment portion 61 is fixed to the left side edge portion of the lower surface of the back sheet 33 via the adhesive 58. A first end of the connection portion 62 having a cylindrical shape is fixed to an end portion of the panel-side attachment portion 61 on a side opposite to the back sheet 33. The vehicle-body-side attachment portion 63 having a shape of a cone with its top portion being planarly cut is fixed to a second end of the connection portion 62. The outer diameter of the connection portion 62 is smaller than the diameter of the first attachment hole 29, and the outer diameter of the end portion of the vehicle-body-side attachment portion 63 on the connection portion 62 side is larger than the diameter of the first attachment hole 29. The connection portion 62 is positioned within the first attachment hole 29, and the vehicle-body-side attachment portion 63 is positioned below the support portion 22A.

For example, when an inertia force acts on the solar panel 30 due to the movement of the hood 14 at the open position to the closed position, this inertia force moves the solar panel 30 to the bottom surface configuring portion 21 (support portion 22A) side. In this case, when the connection portion 62 moves downward relative to the first attachment hole 29 (the support portion 22A), the moving force of the solar panel 30 to the bottom surface configuring portion 21 side is absorbed. Accordingly, there is a small possibility that the first coupling member 60 violently collides with the bottom surface configuring portion 21 (the support portion 22A) due to this inertia force to cause the bottom surface configuring portion 21 to generate a large reaction force due to the collision and transmit the reaction force to the solar module 30S via the first coupling member 60. Thus, there is a small possibility that a connection portion between the solar module 30S and the panel-side attachment portion 61 is damaged or the solar module 30S is damaged due to such a reaction force.

Further, in some cases, for example, the glass 31 is damaged due to movement of the hood 14 at the open position to the closed position or collision of a stone or the like to the solar panel 30, and the solar panel 30 is raised upward relative to the bottom surface configuring portion 21 by a wind W (a wind pressure) passing through a gap between the glass 31 (the gasket 34) and the hood outer panel 18 (the recessed portion 19) (see FIG. 9). In this case, an upper end portion (a large diameter portion) of the vehicle-body-side attachment portion 63 comes into contact with a lower surface of the support portion 22A without passing upward through the first attachment hole 29. Accordingly, the vehicle-body-side attachment portion 63 prevents the solar panel 30 from greatly moving from the hood 14 to the vehicle outer side.

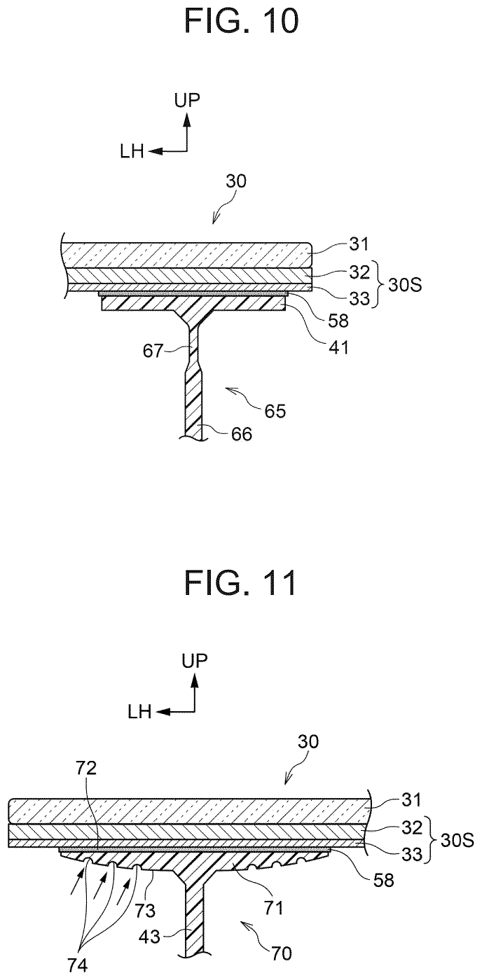

Further, the present disclosure may be carried out in an aspect of a second modification example illustrated in FIG. 10. In the attachment structure for vehicle solar panel of the second modification example, a first coupling member (coupling member) 65 having flexibility includes the panel-side attachment portion 41, a connection portion 66 having a first end connected to the middle portion of the panel-side attachment portion 41, and the vehicle-body-side attachment portion 45 (not shown) connected to a second end of the connection portion 66. The cylindrical portion 47 of the vehicle-body-side attachment portion 45 passes through the first attachment hole 29 of the hood inner panel 27, and the main body portion 46 is positioned above the hood inner panel 27.

The vicinity of the end portion of the connection portion 66 of the first coupling member 65 on the panel-side attachment portion 41 side is configured of a thin portion (low rigidity portion) 67 that is thinner than other parts of the connection portion 66. Accordingly, the thin portion 67 has a lower rigidity and is liable to bend as compared with other parts of the connection portion 66.

For example, when the solar panel 30 is raised upward relative to the bottom surface configuring portion 21 by the wind passing through the gap between the glass 31 (the gasket 34) and the hood outer panel 18 (the recessed portion 19) as described above, the thin portion 67 of the connection portion 66 greatly bends to prevent a force from being generated between the back sheet 33 and the panel-side attachment portion 41 to separate the back sheet 33 and the panel-side attachment portion 41 from each other. Accordingly, there is a small possibility that the back sheet 33 is separated from the panel-side attachment portion 41 in such a case to cause flying of the solar module 30S toward the surroundings of the vehicle body 12.

Further, the present disclosure may be carried out in an aspect of a third modification example illustrated in FIG. 11. In the attachment structure for vehicle solar panel of the third modification example, a first coupling member (coupling member) 70 having flexibility includes a panel-side attachment portion 71, the connection portion 43 having a first end connected to a middle portion of the panel-side attachment portion 71, and the vehicle-body-side attachment portion 45 (not shown) connected to a second end of the connection portion 43. The cylindrical portion 47 of the vehicle-body-side attachment portion 45 passes through the first attachment hole 29 of the hood inner panel 27, and the main body portion 46 is positioned above the hood inner panel 27.

The front shape of the panel-side attachment portion 71 (the shape as viewed along the up-down direction of FIG. 11) is a substantially rectangular shape. One surface in the thickness direction of the panel-side attachment portion 71 having flexibility is a planar first surface 72 to be fixed to the back sheet 33 via the adhesive 58. The other surface in the thickness direction of the panel-side attachment portion 71 is a curved second surface 73. The thickness of the panel-side attachment portion 71 is gradually reduced from the inner peripheral side toward the outer peripheral side. Moreover, in the second surface 73, a plurality of concentric annular grooves (recessed portions) 74 is formed. A sectional shape of each annular groove 74 in a direction orthogonal to an extension direction of the annular groove 74 is, for example, a U-shape or a V-shape. Accordingly, the panel-side attachment portion 71 is easily deformed as compared with the case where no annular groove 74 is formed.

For example, when the solar panel 30 is raised upward relative to the bottom surface configuring portion 21 by the wind passing through the gap between the glass 31 (the gasket 34) and the hood outer panel 18 (the recessed portion 19) as described above, the panel-side attachment portion 71 having the annular grooves 74 formed in the second surface 73 is deformed so as to follow the movement of the solar cell group 32. This prevents a force from being generated between the back sheet 33 and the panel-side attachment portion 71 to separate the back sheet 33 and the panel-side attachment portion 71 from each other. Accordingly, there is a small possibility that the back sheet 33 is separated from the panel-side attachment portion 71 in such a case to cause flying of the solar module 30S toward the surroundings of the vehicle body 12.

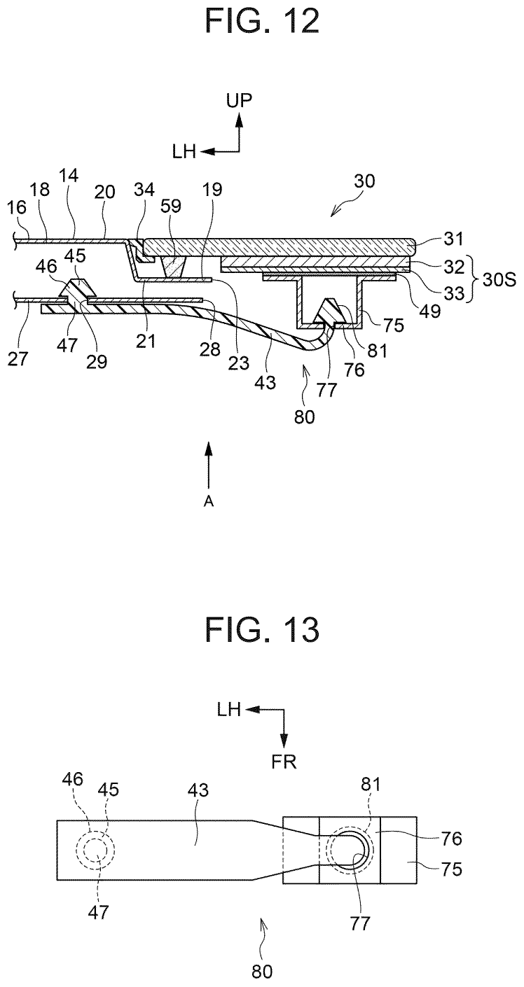

Further, the present disclosure may be carried out in an aspect of a fourth modification example illustrated in FIG. 12 and FIG. 13. In the attachment structure for vehicle solar panel of the fourth modification example, a support member 75 that is made of metal and has a U-shaped cross section is fixed to the back sheet 33. A lower end portion of the support member 75 is configured of a flat-plate-shaped facing portion 76 separated downward from the back sheet 33. A circular attachment hole (through-hole) 77 is provided in the facing portion 76.

A first coupling member (coupling member) 80 of the fourth modification example includes a panel-side attachment portion 81, the connection portion 43 having the first end connected to the panel-side attachment portion 81, and the vehicle-body-side attachment portion 45. The cylindrical portion 47 of the vehicle-body-side attachment portion 45 passes through the first attachment hole 29 of the hood inner panel 27, and the main body portion 46 is positioned above the hood inner panel 27. The panel-side attachment portion 81 is positioned in a space between the back sheet 33 (the adhesive 49) and the facing portion 76, and an end portion of the connection portion 43 on the panel-side attachment portion 81 side passes through the attachment hole 77 so as to be movable. The outer diameter of the lower end portion (the large-diameter end portion) of the panel-side attachment portion 81 is larger than the diameter of the attachment hole 77.

For example, when the solar panel 30 is raised upward relative to the bottom surface configuring portion 21 by the wind passing through the gap between the glass 31 (the gasket 34) and the hood outer panel 18 (the recessed portion 19) as described above, the facing portion 76 (the attachment hole 77) moves in various directions relative to the connection portion 43. That is, the facing portion 76 slides in an axial direction of the attachment hole 77 relative to the connection portion 43, the facing portion 76 moves relative to the connection portion 43 in a direction of being inclined with respect to the axial direction of the attachment hole 77, or the facing portion 76 rotates about the axis of the connection portion 43 relative to the connection portion 43. This prevents a force from being generated between the back sheet 33 and the support member 75 to separate the back sheet 33 and the support member 75 from each other. Accordingly, there is a small possibility that the back sheet 33 is separated from the support member 75 in such a case to cause flying of the solar module 30S toward the surroundings of the vehicle body 12.

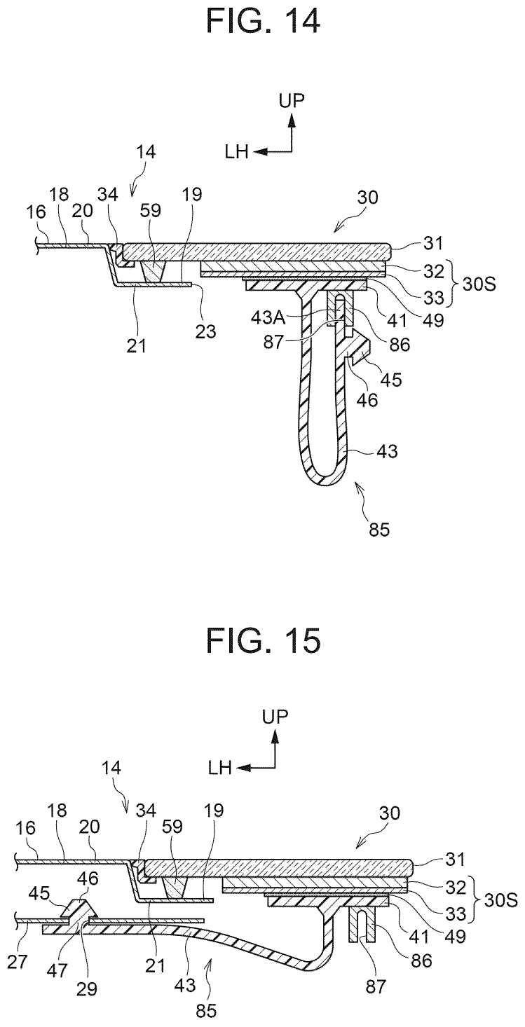

Further, the present disclosure may be carried out in an aspect of a fifth modification example illustrated in FIG. 14 and FIG. 15. In the attachment structure for vehicle solar panel of the fifth modification example, a first coupling member 85 includes a temporary holding portion 86 that has a U-shaped sectional shape and is fixed to the panel-side attachment portion 41. The temporary holding portion 86 can be elastically deformed.

As illustrated in FIG. 14, in a temporary holding groove 87 of the temporary holding portion 86, an end portion 43A of the connection portion 43 on a side opposite to the panel-side attachment portion 41 can be inserted, and thus the end portion 43A can be temporarily held by the temporary holding portion 86. Accordingly, in a state in which the end portion 43A is temporarily held by the temporary holding portion 86, as described above, with the adhesive 59 being brought into contact with the upper surface of the bottom surface configuring portion 21 of the hood outer panel 18, the solar panel 30 can be attached to the body 16 (the recessed portion 19) such that the gasket 34 is brought into close contact with the outer peripheral edge portion of the recessed portion 19.

After that, the end portion 43A is detached from the temporary holding portion 86, and, as illustrated in FIG. 15, the vehicle-body-side attachment portion 45 of the first coupling member 85 is caused to approach the first attachment hole 29 from the lower side of the hood inner panel 27, and the upper end portion (the small-diameter end portion) of the main body portion 46 is pushed into the first attachment hole 29. Thus, the main body portion 46 can be positioned above the hood inner panel 27, and the cylindrical portion 47 can be positioned within the first attachment hole 29.

The work of attaching the solar panel 30 to the body 16 (the recessed portion 19) can be executed in a state in which the end portion 43A is temporarily held by the temporary holding portion 86 as described above, and hence the solar panel 30 can be attached to the body 16 while the connection portion 43 is prevented from being sandwiched between the solar panel 30 and the body 16 (the recessed portion 19). Accordingly, the operator can smoothly execute the work of attaching the solar panel 30 to the body 16.

The attachment structures for vehicle solar panel of the embodiment and all modification examples may include the first coupling member alone.

The shape of the recessed portion formed in the second surface 73 of the panel-side attachment portion 71 may be different from the shape of the annular groove 74.

The attachment structure for vehicle solar panel of the present disclosure may be applied to a vehicle-body configuring member different from the hood 14. For example, the attachment structure for vehicle solar panel may be applied to a roof portion (vehicle-body configuring member) 12R (see FIG. 1) of the vehicle body 12. It is to be noted that, when the attachment structure for vehicle solar panel is applied to the roof portion 12R, the solar panel 30 is not movable relative to the vehicle body 12.

The connection portion of each of the first coupling member and the second coupling member may be a wire made of metal that couples the panel-side attachment portion and the vehicle-body-side attachment portion.

What is claimed is:

1. An attachment structure for vehicle solar panel comprising:
a vehicle-body configuring member configuring a part of a vehicle body;
a solar panel provided on the vehicle-body configuring member, the solar panel including
a glass exposed to an outside of the vehicle body, and
a solar module provided on a vehicle inner-side surface of the glass; and
a coupling member that couples the vehicle-body configuring member and the solar module, wherein:
the coupling member includes:
a panel-side attachment portion connected to the solar module;
a vehicle-body-side attachment portion connected to the vehicle-body configuring member; and
a connection portion that connects the panel-side attachment portion and the vehicle-body-side attachment portion and has flexibility.

2. The attachment structure for vehicle solar panel according to claim 1, wherein the vehicle-body-side attachment portion is a clip including a first engagement portion configured to pass through an attachment hole provided in the vehicle-body configuring member having a plate shape, from one surface side to another surface side of the vehicle-body configuring member while being elastically deformed, the first engagement portion being brought into contact with the other surface after passing through the attachment hole, and a second engagement portion to be brought into contact with the one surface after the first engagement portion passes through the attachment hole, the clip being fixed to the glass.

3. The attachment structure for vehicle solar panel according to claim 1, wherein:
the panel-side attachment portion faces one surface of the vehicle-body configuring member having a plate shape, and is fixed to the solar module;
the connection portion passes through a through-hole provided in the vehicle-body configuring member so as to be movable relative to the through-hole; and
the vehicle-body-side attachment portion faces, from another surface side of the vehicle-body configuring member, the other surface, and is larger in diameter than the through-hole.

4. The attachment structure for vehicle solar panel according to claim 1, wherein:
the panel-side attachment portion is bonded to the solar module; and
a part of the connection portion is a low rigidity portion that is lower in rigidity than another part of the connection portion.

5. The attachment structure for vehicle solar panel according to claim 1, wherein:
one surface in a thickness direction of the panel-side attachment portion having flexibility is a first surface bonded to the solar module; and
a second surface that is another surface in the thickness direction of the panel-side attachment portion includes at least one recessed portion.

6. The attachment structure for vehicle solar panel according to claim 1, wherein:
a support member is fixed to the solar module, the support member including a facing portion that faces the solar module while being separated from the solar module;
the panel-side attachment portion is positioned in a space between the solar module and the facing portion, and is larger in diameter than a through-hole provided in the facing portion; and
the connection portion passes through the through-hole so as to be movable relative to the through-hole.

7. The attachment structure for vehicle solar panel according to claim 1, wherein the panel-side attachment portion includes a temporary holding portion configured to temporarily hold a part of the connection portion.
